(19) United States
(12) Patent Application Publication
(10) Pub. No.: US 2016/0341352 A1
(43) Pub. Date: Nov. 24, 2016

(54) METHOD FOR ANTI-FIRE INSULATION AND THERMAL INSULATION OF WELDED JOINTS OF PRE-INSULATED PIPES DURING ABOVE-GROUND PIPELINE LAYING

(71) Applicants: Oil Transporting Joint Stock Company "Transneft", Moskva (RU); Joint-stock company "Transneft Siberia", Tyumen (RU); L.L.C. "Transneft Research and Development Institute for Oil and Oil Products Transportation", Moskva (RU)

(72) Inventors: Aleksei Nikolaevich Sapsai, Moskva (RU); Vitaly Ivanovich Surikov, Balashikha (RU); Inna Yakovlevna Fridlyand, Moskva (RU); Vyacheslav Vladimirovich Pavlov, Sankt-Peterburg (RU); Pavel Olegovich Revin, Aprelevka (RU); Pavel Ivanovich Shoter, Moskva (RU)

(21) Appl. No.: 15/227,857

(22) Filed: Aug. 3, 2016

Related U.S. Application Data
(63) Continuation of application No. PCT/RU2014/000212, filed on Mar. 28, 2014.

(51) Int. Cl. F16L 59/20; F16L 58/18; F16L 13/02

(52) U.S. Cl. CPC F16L 59/20; F16L 13/0272; F16L 58/181

(57) ABSTRACT

The invention relates to fire and heat insulation of pipes, and specifically to the installation of fire and heat insulation on welded joint of pipes that are used for transporting oil and oil products. The method for installing heat insulation of welded joints of pipes for above surface pipelining includes providing anticorrosive protection of the welded joint of pipes using a heat-shrinkable polymeric tape, installation of glass foam pipe coverings on the joint, fastening the pipe coverings using tie bands with locks, sticking hot-melt adhesive tape on the edges of the protective envelope of the pipe overlapping the glass foam pipe coverings, and mounting a protective galvanized metal housing symmetrically to a center of the welded joint.

The technical result provides anticorrosive protection and heat insulation of the welded joint, and the proposed method reduces cost and complexity of installation.

### CROSS-REFERENCE TO RELATED APPLICATIONS

This application claims the benefit and priority of PCT Pat. App. No. PCT/RU2014/000212, titled METHOD FOR ANTI-FIRE INSULATION AND THERMAL INSULATION OF WELDED JOINTS OF PRE-INSULATED PIPES DURING ABOVE-GROUND PIPELINE LAYING and filed on Mar. 28, 2014, also published as WO/2015/147677.

### FIELD

The invention relates to construction of pipelines and can be used for heat and fire insulation of fixed welded joints of pre-insulated pipelines used for transporting oil and oil products in adverse climatic conditions at low temperatures.

### BACKGROUND

Various fabrications of heat-insulating joints of pre-insulated pipelines are known. For example, patent for invention GB2319316, published on 20 May 1998, IPC F16L 59/20, discloses one such fabrication. This fabrication includes joining the pipelines' ends to each other, installing a polymeric coupling on the joint with its ends covering the ends of polymeric jackets of the pipelines, welding the coupling's longitudinal weld, joining the coupling with the ends of jackets of the pipelines to be coupled, checking for tightness of the coupling and jackets, and filling the space between the inner and outer surface of the coupling. The outer surface of the joined pipelines and ends of the pipeline include heat insulation with heat-insulating material.

Another method for joining isolated metal pipes is disclosed by patent for invention GB1483143, published on 17 Aug. 1977, IPC F16L 59/20. According to this reference, two metal pipes, each of which has a hose made of insulating material such as rigid polyurethane foam, and end lugs at a distance from the pipe edge are welded and insulated with an additional heat-insulating material. The heat-insulating material includes two half sections, which are disposed around the weld. The hoses include heat-shrinkable plastic material that is placed on the additional heat-insulating material and on a portion of a bush that is connected to each pipe. The bush is heated to capture the insulating material. Optionally, the sealing bush made of material used for the hose is installed over the end of the insulation on the pipe before installing the bush, and the welded joint is covered with anticorrosive coating prior to application of an additional insulating material.

Another method for sealing the joint between two insulated pipes is disclosed by patent for invention EP0079702, published on 14 May 1986, IPC F16L 59/20. According to this reference, water and heat insulation of welded joints of pipes is made using heat-shrinkable materials and heat-insulating pipe coverings. The outer joint between the pipeline and the housing, that covers the heat-insulating pipe coverings, is further protected with heat-shrinkable material. The polymeric material is coated with a sealant, such as mastic, and heat-activated adhesive, such as hot melt adhesive. The coated material forms a bush which can have a tubular or circular configuration. The sealant provides a flexible waterproof seal around the welded joint, and the adhesive provides a second seal and prevents any movement of the hose and the pipe.

Another method of providing an anticorrosive insulation of welded joints of a pipeline and a device for its implementation are disclosed by patent for invention RU2398155, published on 10 Aug. 2012, IPC F16L 13/02. According to this reference, a heat-shrinkable coupling is first placed on the pipeline near a joint before welding the pipeline ends. After the joints have been welded, the surface to be insulated is cleaned with metal brushes, drained from moisture, and coated with a primer and mastic tape, which is a coating with softening mastic material temperatures of 80 degrees Celsius (80 ° C.) and 90 ° C. Afterwards, the heat-shrinkable coupling is shifted, mounted in the area of the welded joint symmetrically to the joint, and heated to shrinkage temperature of 110-120 ° C. The mastic tape layers are heated and melted through the heat-shrinkable coupling to ensure simultaneous pressure on the molten mastic of the mastic tape to use it for filling the cavities in the area of the welded joint reinforcement (tent areas) and the places of transition to the base coating and overlapping layers of the mastic tape.

A method of fire inserts is disclosed by patent for utility model RU72524, published on 20 Apr. 2008, IPC F16L 3/00. This reference discloses a design of a pipe for an above-ground pipeline that includes a metal pipe covered with heat insulation and protective coating. The heat insulation is applied to the ends of the metal pipe and the central portion of the pipe on both sides is separated from the heat insulation by washers with rubber O-rings. The central portion is filled with non-combustible material, such as basalt wired mat for preventing flame propagation. S

A heat-insulating joint of pre-insulated pipelines is disclosed by patent for invention RU2235246, published on 20 May 2010, IPC F16L 59/18). The heat-insulating joint of pre-insulated pipelines is interconnected by welding and includes a metal housing, wrapped around the joint and arranged symmetrically to the joint center. The joint also includes polyurethane foam filling the space between the inner surface of the metal housing, the outer surface of interconnected pipelines and the ends of the heat-insulating material of these pipelines. A polymeric coating is used as a heat-shrinkable fabric with an adhesive layer superimposed on the metal housing. The heat-shrinkable polymeric coating is connected with its ends covering the low-pressure polyethylene envelopes. The metal housing has a filling orifice and a conical plug. The heat-insulating joint of pre-insulated pipelines is implemented as follows. A metal housing is mounted symmetrically to the joint center by wrapping it around the joint. The space between the inner surface of the housing, the outer surface of interconnected pipelines and the ends of the heat-insulating materials of these pipelines is filled with polyurethane foam. After that the surface of the metal housing in the joint area is activated by heating it with a gas burner flame of 90-100 ° C. The polyethylene envelope and metal housing are covered with an applicator made of heat-shrinkable fabric and heated to the sweating temperature, then, the surface of the metal housing is re-activated in the area of joint to a temperature of 90-100° C. Next, the temperature of the polyethylene envelope and the metal housing is maintained and the adhesive layer is heated by a gas-burner and gradually covered with heat-shrinkable fabric with little effort applied on the joint upwards. The overlapping edges are placed at 11 and 13 hours on a clock face and oriented from downward. The overlapping area of the heat-shrinkable fabric is laid with the heated inner surface of the locking plate, and the fabric is heat-shrunk by heating with a soft burner flame. Furthermore, the edge of the polyethylene envelope and heat-shrinkable fabric is laid with the inner surface of the applicator heated by a gas burner to a sweating temperature. The metal housing is fixed with two binding bands one on each end. The space of the joint to be insulated is filled with polyurethane foam through a hole in the metal housing. After filling the insulated space of the joint with polyurethane foam, the filling orifice is covered with a lid, which is fixed by means of a previously prepared binding band, leaving the gap between the housing and the lid less than 1 mm for air to exit.

However, this method is inefficient in terms of fire protection, since the material used to insulate the joint, polyurethane foam, is combustible. In addition, this method cannot be applied in field conditions in a climate having low ambient temperatures that reach minus 60° C., such as in the installation of heat insulation of pipelines joints in the Far North in wintertime. This is because such methods require maintaining a constant positive ambient temperature while pouring polyurethane foam in the area of joint and a positive pipe temperature for the polyurethane foaming.

### SUMMARY

The object of the invention is to provide a novel method for forming fire and heat insulation on welded joints of pre-insulated pipes (i.e., pipes with factory-fitted insulation). Such pipes may be used in an above surface pipeline to transport oil and oil products in adverse climatic conditions (i.e., at relatively low temperatures such as temperatures reaching minus 60° C.).

The technical result is a simple structure that operates reliably in adverse climatic conditions (i.e., relatively low temperatures as discussed above) and provides heat insulation of welded joints of pre-insulated pipes that is relatively durable. At the same time, the structure provides protection against the spread of fire on factory-fitted heat insulation positioned on metal pipes if a fire is ignited on the pipeline.

The solution that provides these results is a method of forming a heat insulated welded joint of pipes that have factory-fitted heat insulation. The heat insulation for the welded joints is covered with a protective metal envelope. The heat insulated welded joint may be formed above the ground as opposed to buried beneath the ground. The metal end portions that are welded together may be free from factory-installed anticorrosive coating. The joint may include a gasket made of heat-shrinkable polymeric tape with a locking (clamping) plate. The joint may also include a heat-insulation coating consisting of glass foam (cellular glass) pipe coverings that are mounted on the gasket and provided as semi-cylinders or segments of another form. The geometrical dimensions of the pipe coverings allow for close positioning of the pipe coverings to adjacent ends of the factory-fitted heat insulation. A protective metal envelope of the pipes is aligned with the insulating pipe coverings. The metal envelope and the insulation (pipe coverings) form a smooth outer surface. The pipe coverings are fastened with tie bands having locks. The joint between the metal envelope and the pipe coverings is subsequently sealed using a hot-melt adhesive tape. A metal housing made of galvanized sheet metal is positioned about the protective metal envelope of the pipes. In particular, the metal housing is wrapped around the joint having the heat insulation coating and the loose ends of the metal housing are arranged on the side of the joint such that they overlap. The loose ends are pre-tied to fully cover the heat insulation coating and are secured with fasteners.

End edges of the factory-fitted pipe heat insulation and adjacent pipe coverings may be made to form a tool joint during assembly. This provides, for example, a stepped shape along a longitudinal axis of the above-mentioned edges.

In a particular embodiment of the invention, the pipe coverings are selected to have a width equal to the distance between the edges of the factory-fitted heat insulation of the pipes and may have an acceptable technological gap of not more than 7 mm. The pipe coverings are mounted on the gasket and, before getting bound, are tied up with temporary belts until they are closely connected to each other and to adjacent edges of the factory-fitted heat insulation. The belts have a tensioning mechanism and are removed after bonding the pipe coverings with tie band with locks. No less than 3 tie bands are used—one in the middle of the welded joint, and two at the ends of the joint, such as at a distance of 150 to 200 mm from the edge of the factory-fitted heat insulation. Temporary belts with a tensioning mechanism are also used to pre-tie the galvanized metal sheet until it entirely covers the heat insulation coating. After connecting the metal sheet, the belts are removed.

In a particular embodiment of the invention, before installation of the gasket, the surface of the welded joint and the adjacent area (metal end sections of welded pipes) are prepared. This preparation includes abrasive-blast cleaning of the metal surface and drying to a predetermined temperature measured using four contact thermometers positioned at equidistant points around the perimeter of the welded joint. Before installing the gasket, the prepared surface is coated with a uniform layer of primer, such as two-component epoxy primer.

When installing the gasket, one loose end of the heat-shrinkable polymeric tape is heated and then fastened to the upper generatrix of end sections of welded pipes. The tape is then wrapped around the end sections of the welded pipes, forming a sag, and the second end of the tape is positioned on the first end, overlapping at least 100 mm. The tape is then heated and fixed on the first end and the area where the tape overlaps is secured with a locking (clamping) plate. The tape is rolled using a silicone roller to remove air bubbles, after which the heat-shrinkable polymeric tape is heated in the sag area to make it shrink according to dimensions of the end section of the pipes. The heat-shrinkable polymeric tape has a minimum thickness of 2 mm for pipes up to 820 mm in diameter, and not less than 2.4 mm for pipes with a diameter of over 820 mm. Heat-shrinkable polymeric tape (i.e., the gasket) is set to overlap the factory-fitted anticorrosive coating of the connected pipes by no less than 50 mm for pipes up to 530 mm in diameter, and at least 75 mm for pipes over 530 mm in diameter. Heat-shrinkable polymeric tape includes a material having a degree of shrinkage between 15 percent (15%) and 30% in the longitudinal direction. In this case, the tape has a length “L”, determined using the formula: L=π·D·1.05+150, mm, where “D” is the outer diameter of the pipe in mm.

The locking (clamping) plate represents a measuring section of the reinforced heat-shrinkable tape where the adhesive layer has a higher melting temperature relative to the gasket heat-shrinkable tape. Reinforced heat-shrinkable tape having a thickness between 1.4 mm and 1.6 mm and a degree of shrinkage in the longitudinal direction between 2% and 5% may be used as the locking plate.

In a particular embodiment the mounted gasket is inspected. Such inspection includes checking the appearance of the gasket and the size of the overlap of the gasket (heat-shrinkable polymeric tape) on the factory-fitted anticorrosive coating of the metal end sections of the welded pipes. The inspection also includes checking the gasket thickness, its dielectric continuity, which should be at least 5 kilovolts per mm (kV/mm), and the adhesion of the gasket to the welded joint and to the pipe section with factory-fitted anticorrosive coating, which should be at least 70 Newtons per centimeter (N/cm).

In a particular embodiment the hot-melt adhesive tape is applied in two layers on the joint between the factory-fitted heat insulation with the protective metal envelope and the glass foam pipe coverings. The overlapping of the tape on the protective metal envelope of the pipe corresponds to the overlapping of the metal housing on the same. Before installing the hot-melt adhesive tape, the metal protective envelopes of the pipes to be welded are marked with the boundaries of the position of the galvanized metal housing to ensure equal overlap on the said protective metal envelopes. The hot-melt adhesive tape is positioned on the marked boundaries overlapping the heat insulation coating made of pipe coverings. Hot-melt adhesive tape is selected to have a minimum thickness of 2 mm and a length “L” determined from the formula: L=π·D+10, where “D” is the outer diameter of the envelope, measured in mm.

The metal housing is to be mounted symmetrically with respect to the welded joint with an overlap on the protective metal envelope of at least 100 mm. The galvanized metal housing overlap areas, including overlapping loose ends, and the protective metal envelope around the edges of the housing are fastened using galvanized self-tapping screws with a press washer at intervals of between 80 and 100 mm, and at a distance from the edge of the housing between 10 and 20 mm. After installation of the housing, the appearance of heat insulation, the size of overlap on the protective metal envelope, and the distance between the screws and the housing edge are inspected.

Another solution that provides the technical result is a design of a heat-insulated joint of pipes that includes a particular composition of elements and their relative positioning. A heat-insulating joint comprises a gasket made of heat-shrinkable polymeric tape with locking (clamping) plate. The gasket is mounted on the surface of metal end sections of welded pipes. The joint also includes a heat insulation coating made of glass foam pipe coverings that are mounted on the gasket. The glass foam pipe coverings are semi-cylinders or segments of another shape with geometric sizes that ensure that they are positioned relatively close to the adjacent ends of the factory-fitted heat insulation to form a smooth outer surface. The pipe coverings are fastened with tie bands with locks and are covered with a metal housing, which is mounted symmetrically to the welded joint overlapping the factory-fitted metal envelope of pipes. The joint between the metal envelope of the pipe and the pipe coverings is sealed using a hot-melt adhesive tape. The metal housing is made of galvanized sheet metal, whose loose ends overlap and are placed on the upper portion of the pipe. The loose ends are secured by fasteners.

Design features that characterize both the heat-insulating joint and its individual constituent elements are listed in the description of the embodiment of the welded joint heat insulation (see above).

Thus, the invention involves the use of demountable heat insulation, thereby providing an easy, fast and reliable heat insulated and fire-resistant insulation of a welded joint of a collection of pipelines in the field. The proposed improved method for mounting fire and heat insulation on the pipeline is less labor intensive and more cost effective than the closest analogue. At the same time, this heat insulation design for above-ground pipeline has the desirable resistance against external natural and artificial mechanical effects.

### BRIEF DESCRIPTION OF THE DRAWINGS

The features of the disclosure are illustrated by the following drawings.

FIG. 1 is a diagram illustrating a welded joint heat insulation design without a housing installed;

FIG. 2 is a diagram illustrating the mounting of a metal housing for heat insulation of the welded joint of FIG. 1 for above surface pipes; and

FIG. 3 is a diagram illustrating edges of pipe coverings and adjacent factory-fitted insulation, the edges having a stepped shape.

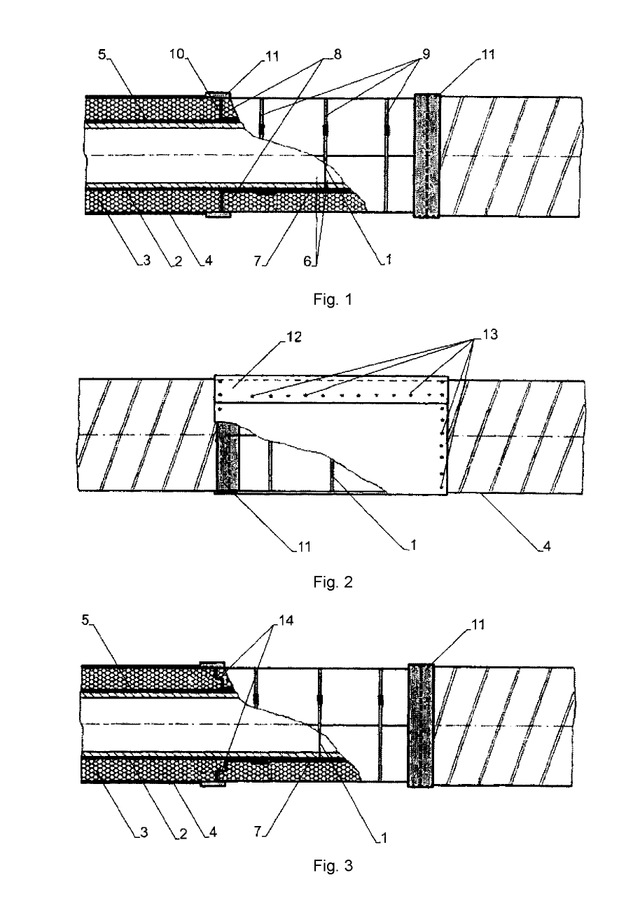

### DETAILED DESCRIPTION

The drawings include the following elements along with their corresponding reference numbers:
1. welded joint,
2. steel pipe,
3. factory-fitted heat insulation of the steel pipe,
4. protective metal envelope of the steel pipe (outer),
5. factory-fitted anticorrosive coating of the steel pipe,
6. metal end sections of welded pipes,
7. a gasket made of heat-shrinkable polymeric tape for preliminary anticorrosive protection of the welded joint,
8. glass foam (cellular glass) pipe coverings, forming heat insulation coating,
9. tie metal bands with a lock mounted on pipe coverings,
10. a joint between the factory-fitted heat insulation 3 with a protective metal envelope 4 and pipe coverings 8,
11. heat-shrinkable polymeric tape applied on joint 10,
12. a metal housing made of galvanized metal sheet,
13. fasteners.

The locking plate mounted on the heat-shrinkable polymeric tape and the temporary belts with tensioning mechanisms that are mounted on the pipe coverings and metal housing are not shown in the drawings.

Definitions:

A protective metal envelope of a metal pipelining (factory-fitted) is a cylindrical structure mounted on the outer surface of the pipe heat insulation to protect it from mechanical damages and environmental impacts.

Glass foam pipe coverings are segments made of glass foams and are formed by pouring glass foam in a special form.

An exemplary method of installation of fire and heat insulation of welded joints of pipes for the above surface pipelining is implemented as follows.

The disclosure is intended primarily for use in above-ground construction on severe climatic conditions (at i.e., relatively low temperatures such as those reaching minus 60° C.) of a pipeline system to transport oil and oil products. The pipeline system for these conditions is constructed of pre-insulated pipes (provided as sections) with having a diameter up to 1,020 millimeters (mm). The sections have i.e. having the factory-fitted heat insulation 3 positioned about steel pipes 2, and covered with an anticorrosive coating 5, and a protective metal envelope 4. Pipes The pipes 2 have end sections 6, free from factory-fitted heat insulation, and a portion of a surface of the end section 6 surface is covered with the anticorrosive coating 5. The end sections 6 of pipes 2 are welded in the field to form a pipeline system to form a welded joint 1. If there is a positive opinion on the quality of welded joint of pipes (i.e., the welded joint 1 has been determined to be acceptable), welded joint heat insulation works are launched (i.e., steps to install a fire resistant thermal insulation are performed).

The steps for installing the heat insulation of the welded joint 1 include applying a preliminary anticorrosive protection of to the welded joint using a gasket 7 made of heat-shrinkable polymeric tape. To do this, the surface of the welded joint is prepared at a distance of not less than 200 mm from the joint. The surface of the welded joint is cleaned of to remove dirt, dust, grease, moisture, and the like, and is then dried by heating with a gas burner to a predetermined temperature. The predetermined temperature depends on the grade of the heat-shrinkable polymeric tape, c. The temperature is checked using multiple contact thermometers positioned at four equidistant points around the perimeter of the welded joint. If the surface is heated above the desired temperature, heating is stopped to reach the temperature normative values such that the temperature can be reduced to the predetermined temperature. The metal surface is cleaned using a blast abrasive method, which includes cleaning of the area of the factory-fitted anticorrosive coating of the pipe that is adjacent to the cleaned area, at a distance of not less than 100 mm from the edge of the anticorrosive coating of the pipe anticorrosive coating. Next, the prepared surface is coated with an even layer of primer, such as a two-component epoxy primer (comprising an epoxy resin and a hardener). The time from the start of mixing of primer components to its application on the pipe surface should not exceed the time indicated in the manufacturer's technical documentation for the primer.

The gasket made of heat-shrinkable polymeric tape is mounted on the surface that is coated with primer. For this purpose, the cleaned surface in the area of the welded joint is heated to the temperature specified by the manufacturer of the heat-shrinkable polymeric tape (such as between 95° C. and 105° C.) using a gas-burner, for subsequent application of heat-shrinkable polymeric tape. The heating temperature parameters of the cleaned pipe surface are determined based on the parameters of the particular brand and composition of the heat-shrinkable polymeric tape. The heat shrinkable polymeric tape is a two-layer insulating material consisting of a heat and light stabilized, electronically or chemically sewed, longitudinally oriented polymeric layer of the tape and an adhesive layer (adhesive) that may include hot-melt polymer compounds specified by the manufacturer. While applying heat-shrinkable polymeric tape on the surface of the welded joint, the welded joint temperature is also measured using a contact thermometer in four equidistant points around the perimeter of the welded joint. The thickness of the heat-shrinkable polymeric tape gasket is chosen depending on the diameters of the pipes used (see Table 1 below).

TABLE 1
The thickness of the coating area of welded
joints depending on the pipeline diameter.

| | Minimum coating thickness, |
|---|---|
| Pipeline diameter, mm | mm, not less than |
| Up to 273 | 1.2 |
| Over 273 to 530 | 1.8 |
| Over 530 to 820 | 2.0 |
| Over 820 | 2.4 |

The gasket of heat-shrinkable polymeric tape 7 is mounted around the welded joint 1. The polyethylene coating is on top and the lower adhesive layer is applied to the welded joint, with the upper end overlapping the lower one. The size of the overlap should be at least 100 mm. When mounting the heat-shrinkable polymeric tape, the lower end is heated using a burner flame on the side of the adhesive layer, preventing the shrinkage of polyethylene, and is then pressed to the surface of the welded joint coated having the primer. The size of overlap of the heat-shrinkable polymeric tape on the factory-fitted anticorrosive coating adjacent to the welded joint area is at least 50 mm for pipelines having a diameter up to and including 530 mm, and at least 75 mm for pipelines having a diameter greater than 530 mm.

The heat-shrinkable polymeric tape is wrapped around the insulated surface with a “sag” located at the bottom of the forming pipe. Then, its second end (top) is also heated with a burner on the side of the adhesive layer and placed overlapping over the lower end. The overlap of the heat-shrinkable polymeric tape ends is rolled using a roller to remove any air bubbles. Thus, the heat-shrinkable polymeric tape, when closed in a ring, has the “sag” of the fabric that will be later shrunk. Then the area of the upper end of the heat-shrinkable polymeric tape overlapping the lower end is fastened with a locking plate, which is a measuring section of a reinforced heat- shrinkable tape having a higher adhesive layer melting temperature than the heat-shrinkable polymeric tape gasket. The locking plate is heated with a burner flame and is mounted directly on the overlap of the tape ends with the adhesive layer downwards and the polyethylene layer upwards. This provides the advantage of preventing the “opening” of the overlap of the tape ends during installation and shrinkage of the tape. After installation, the locking plate is heated with a yellow burner flame until the overlapping contours are visible underneath. Afterwards, the assembly is rolled to the surface of the pipe using a roller to remove any air bubbles and to level the entire material. The shrinkage of the heat-shrinkable polymeric tape gasket is started immediately after the installation of the plate using a burner, evenly distributing the flame, from the bottom of the forming pipe, that is, the area of the maximum tape sag. A preferred shrinkage is performed from the center of the tape to one side and then from the center of the tape to the other side, moving the burner around the diameter of the pipe, while avoiding overheating of the tape fabric. If a uniform and simultaneously intensive heating is performed, the tape shrinks without air bubbles and buckles.

After applying anticorrosive protective coating on the welded joint in the form of the gasket 7 made of heat-shrinkable polymeric tape, the coating is inspected. In particular, the following features of the coating are inspected: its appearance, the size of overlap on the factory-fitted anticorrosive coating 5, the gasket thickness, its dielectric continuity (which should be of at least 5 kilovolts per mm (kV/mm)), and the adhesion of the gasket to the welded joint and the pipe section with factory-fitted anticorrosive coating (which should be of at least 70 Newtons per centimeter (N/cm)).

After the inspection, the heat-insulating pipe coverings 8 are installed. The pipe coverings 8 resemble segments of a hollow cylinder and are made of glass foam. The assembled heat insulation coating made of pipe coverings may be a hollow 2-segment cylinder (when the outer diameter of the pipe 2 is up to 820 mm), a hollow 3-segment cylinder (when outer diameter of the pipe 2 is between 820 mm and 1,020 mm), or a hollow 4-segment cylinder (when the outer diameter of the pipe to exceeds 1,020 mm).

The pipe coverings 8 are chosen to have geometrical dimensions that provide the smallest possible gap (less than 0.7 mm) between the pipe coverings 8 and the factory-fitted insulation 3 so that a smooth outer surface is formed with the factory-fitted insulation 3. For that purpose, the distance between the ends of the factory-fitted insulation 3 is measured, and if the pipe coverings' width is bigger than the measured value, the pipe coverings are cut to the desired size. In order to form a smooth outer surface of the mounted pipe coverings and the protective metal envelope 4, the thickness of the pipe coverings at the joint 1 may be less than the total thickness of the factory-fitted insulation layer and the protective metal envelope 4. The size of the pipe coverings 8 may be similar to the gasket 7 made of heat-shrinkable polymeric tape and the pipe coverings 8 may be mounted on the welded joint.

Experimental development carried out in Transneft R&D, LLC showed that the optimal number of pipe coverings is the number indicated in Table 2, depending on the diameter of the pipe.

TABLE 2
The number of pipe coverings depending
on the diameter of the pipe.

| | Number of pipe |
|---|---|
| Pipe diameter, mm | coverings, mm |
| Up to and including 820 | 2 |
| Over 820 to 1,020 inclusive | 3 |
| Over 1,020 | 4 |

When installing two pipe coverings, their joints should be in the positions corresponding to “3” and “9” o′clock (corresponding to positions on a clock face). When installing three pipe coverings, their joints' positions should correspond to “2”, “6”, and “10” o′clock. When installing four pipe coverings, their joints' positions should correspond to “2”, “5”, “8”, and “11” o′clock. Heat insulation coating can be collected from pipe coverings with their transverse joints, and the pipe coverings can have male and/or female tool joints along the entire length of the end surface. This allows for their installation to be close to each other.

The transverse joints are protected with a sealant. Afterwards, temporary belts are mounted on the assembled pipe coverings 8 and tightened to couple the joints of the pipe coverings, reducing the likelihood of damage to the pipe coverings. After that, at least three metal bands 9 having a lock are mounted on pipe coverings. One of the metal bands 9 is in the middle of the welded joint, and two other metal bands 9 are positioned at a distance between 150 mm and 200 mm from the pipe covering edge. The metal bands are tightened using a tensioner.

Next, the joint 10 between the factory-fitted heat insulation 3 with a protective metal envelope 4 and the pipe coverings 8 are sealed with a hot-melt adhesive tape 11. Afterwards, the metal housing 12 is installed symmetrically with the welded joint and overlaps the protective metal envelope 4 of the metal pipe 2. Before installing the hot-melt adhesive tape 11, the metal protective envelope 4 is marked to show the boundaries of positioning of the galvanized metal housing 12, ensuring equal overlap on the protective metal envelope 4. Next, the hot-melt adhesive tape 11 is positioned on the marked boundaries, overlapping the heat insulation coating made of pipe coverings 8.

The hot-melt adhesive tape 11 is installed by heating the metal protective envelope 4 by holding a burner flame to the marked boundaries and applying the hot-melt adhesive tape in two layers, overlapping the tape, on the pipe coverings 8. The combined two layers of hot-melt adhesive tape may be 200 mm plus or minus 5 mm wide and 2.0 mm plus or minus 0.2 mm thick. Then, the metal housing 12 made of galvanized sheet metal is wrapped around the portion of the pipe having the heat insulating coating made of pipe coverings 8. The loose ends of the metal housing 12 are placed on the side of the upper forming pipe with an overlap oriented downward. The overlap should be in the positions corresponding to “1” to “2” o′clock or from “10” to “11” o′clock and should be at least 100 mm. This metal housing is pre-bound using belts with a tensioning mechanism (not shown) to fully extend around the heat insulation coating 8. Afterwards, the housing edges are heated using a gas burner flame to melt the hot-melt adhesive tape positioned underneath, and the belts with tensioning mechanism are finally tightened and then removed after bonding the sheet with tie bands with locks or using fasteners 13. Fasteners, such as galvanized self-tapping screws having a press washer are positioned at every 80-100 mm and at 10-20 mm from the housing edge. The deviation of the placement of fasteners from the line should not exceed 5 mm. After being installed, the metal housing 12 should cling to the heat insulation coating made of pipe coverings 8.

The quality of the heat insulation installation and the protective coating of the metal (galvanized) housing 12 is determined by visually inspecting the appearance of the insulation installation and metal housing 12, the size of overlap on the factory-fitted protective metal envelope of pipes (on the pipe perimeter), the size of the overlap of the housing ends against each other and positioned along the generatix, and the distance between the screws and the housing edge.

The use of a method similar to the above ensures anticorrosive protection and heat insulation of the welded joint of the oil pipeline while simplifying installation procedures of such heat insulation of joints of pipelines intended for above surface lying at low temperatures. The method also increases the service life of welded pipes and allows for improvement of the heat insulation installation technology on pipelines, which in turn reduces the cost of installation and complexity of installing pipelines.

What is claimed is:

1. A method of providing fire and heat insulation of a welded joint of pipes to be laid above ground and having a factory-fitted heat insulation, a protective metal envelope, and factory-fitted anticorrosive free end portions, comprising:
positioning a gasket having heat-shrinkable polymeric tape about the welded joint;
positioning a heat insulation coating having glass foam pipe coverings about the gasket, the glass foam pipe coverings including at least two segments of a shape that defines an opening for receiving the welded joint, the glass foam pipe coverings having geometrical dimensions that are similar to a space between the factory-fitted heat insulation of the pipes, the heat insulating coating being aligned with the protective metal envelope of the pipes;
covering transverse joints of the glass foam pipe coverings with a sealant;
fastening the glass foam pipe coverings with tie bands having locks;
sealing a joint between the protective metal envelope and the glass foam pipe coverings using a hot-melt adhesive tape;
installing a metal housing such that it overlaps the protective metal envelope of the pipes and is positioned around the heat insulation coating, the metal housing being made of galvanized sheet metal and having loose ends that overlap near a top of the welded joint;
retaining the metal housing in place about the heat insulation coating; and
securing the metal housing in place using fasteners.

2. The method of claim 1, further comprising forming a tool joint between the ends of the factory-fitted heat insulation and adjacent pipe coverings by forming a stepped shape in a longitudinal direction in the factory-fitted heat insulation and the adjacent pipe coverings.

3. The method of claim 1, further comprising tying the glass foam pipe coverings together using temporary belts until they are adjacent to each other and to adjacent edges of the factory-fitted heat insulation prior to fastening the glass foam pipe coverings with the tie bands, and removing the temporary belts after fastening the glass foam pipe coverings with the tie bands.

4. The method of claim 1, wherein retaining the metal housing in place about the heat insulating coating includes retaining the metal housing using temporary belts with a tensioning mechanism and applying torque to the tensioning mechanism.

5. The method of claim 1, further comprising:
abrasive blast cleaning the welded joint and the end portions of the pipes prior to positioning the gasket about the welded joint;
placing four contact thermometers equidistant about a perimeter of the welded joint;
drying the welded joint to a predetermined temperature based on measurements from the four contact thermometers; and
applying a uniform layer of primer to the cleaned and heated welded joint and end portions of the pipes prior to positioning the gasket about the welded joint.

6. The method of claim 1, further comprising:
heating a loose end of the heat-shrinkable polymeric tape;
fastening the loose end of the heat-shrinkable polymeric tape to an upper generatrix of the end portions of the pipes;
wrapping the heat-shrinkable polymeric tape around the end portions of the pipes such that the heat-shrinkable polymeric tape has a sag;
positioning a second loose end of the heat-shrinkable polymeric tape over the first loose end such that the second loose end overlaps the first loose end by at least 100 millimeters (100 mm);
heating the second loose end and fastening the second loose end on the first loose end;
securing the overlap of the first loose end and the second loose end using a locking plate having a higher adhesive layer melting temperature than that of the gasket; and
shrinking the heat-shrinkable polymeric tape by heating the sag such that the heat-shrinkable polymeric tape has a thickness of at least 2 mm when a diameter of the pipes is less than or equal to 820 mm and has a thickness of at least 2.4 mm when the diameter of the pipes is greater than 820 mm.

7. The method of claim 1, wherein the heat-shrinkable polymeric tape is positioned to overlap a factory-fitted anticorrosive coating of the pipes by at least 50 mm when a diameter of the pipes is less than or equal to 530 mm, and at least 75 mm when the diameter of the pipes is greater than 530 mm.

8. The method of claim 1, further comprising determining a quality of the gasket by inspecting an appearance of the gasket, measuring an amount of overlap of the gasket on a factory-fitted anticorrosive coating of the pipes, measuring a thickness of the gasket, measuring a dielectric continuity of the gasket to ensure it is at least 5 kilovolts per mm, and measuring an adhesion of the gasket to the welded joint and to pipe sections that include the factory-fitted anticorrosive coating to ensure it is at least 70 Newtons per centimeter.

9. The method of claim 1, further comprising cutting the glass foam pipe coverings to have a width that is within 7 mm of a distance between factory-fitted heat insulation of the pipes.

10. The method of claim 1, wherein the hot-melt adhesive tape is applied to the joint in at least two layers and wherein an amount of overlap of the hot-melt adhesive tape on the pipe corresponds to a size of overlap of the metal housing on the pipe.

11. The method of claim 1, wherein the hot-melt adhesive tape is chosen with a minimum thickness of 2 mm and a length L determined from the ratio: L=π·D+10, where D is the outer diameter of the envelope, mm.

12. The method of claim 1, wherein the heat insulation coating has a thickness that is less than a sum of a thickness of the factory-fitted heat insulation and a thickness of the protective metal envelope.

13. The method of claim 1, further comprising validating an installation by visually inspecting an appearance of the heat insulation coating, measuring a size of overlap of the metal housing on the factory-fitted protective metal envelope, and measuring a distance between each of the fasteners and between an edge of the metal housing and the fasteners.

14. A heat-insulating joint of pipes to be laid above ground and having a factory-fitted heat insulation positioned about a welded joint, a protective metal envelope, and factory-fitted anticorrosive free end portions, comprising:
a gasket of heat-shrinkable polymeric tape positioned about the welded joint;
a heat-insulation coating having glass foam pipe coverings positioned about the gasket and including at least two segments of a shape, and having geometrical dimensions that are similar to a space between factory-fitted heat insulation of the pipes;
a sealant covering transverse joints of the glass foam pipe coverings;
a tie band positioned about the glass foam pipe coverings;
a hot-melt adhesive tape sealing a joint between the protective metal envelope of the pipes and the glass foam pipe coverings; and
a metal housing including galvanized sheet metal, being positioned about the glass foam pipe coverings, overlapping the protective metal envelope of the pipes, and having loose ends that overlap near a top of the welded joint.

15. The heat-insulating joint of claim 14, wherein edges of the factory-fitted heat insulation and edges of adjacent pipe coverings have a stepped shape in a longitudinal direction to form a tool joint.

16. The heat-insulating joint of claim 14, wherein the heat-shrinkable polymeric tape has a thickness of at least 2 mm when the pipes have a diameter that is less than or equal to 820 mm, and a thickness of at least 2.4 mm when the diameter of the pipes is greater than 820 mm, and wherein an overlap of edges of the heat-shrinkable polymeric tape is at least 100 mm, and is positioned on an upper generatrix of the end portions of the pipes.

17. The heat-insulating joint of claim 14, wherein the heat-shrinkable polymeric tape overlaps a factory-fitted anticorrosive coating of the pipes by at least 50 mm when a diameter of the pipes is less than or equal to 530 mm, and at least 75 mm when the diameter of the pipes is at least 530 mm.

18. The heat-insulating joint of claim 14, wherein the heat-shrinkable polymeric tape has a shrinkage degree that is between 15% and 30% in a longitudinal direction and includes a locking plate having a reinforced heat-shrinkable tape having a degree of shrinkage in a longitudinal direction that is between 2% and 5%, and wherein the locking plate has a higher adhesive layer melting temperature than that of the gasket.

19. The heat-insulating joint of claim 14, wherein the tie band includes at least 3 tie bands including a first tie band positioned in a middle of the welded joint and at least two tie bands positioned between about 150 mm and 200 mm from edges of the factory-fitted heat insulation.

20. The heat-insulating joint of claim 14, further comprising fasteners securing the metal housing in place wherein the fasteners include galvanized self-tapping screws and press washers and are spaced apart by between 80 mm and 100 mm on an overlap of the loose ends, and positioned from an edge of the metal housing by between 10 mm and 20 mm.
